(19) United States
(12) Patent Application Publication
(10) Pub. No.: US 2014/0320893 A1
(43) Pub. Date: Oct. 30, 2014

(54) WORKFLOW DETERMINATION

(71) Applicant: Hewlett-Packard Development Company, L.P., Houston, TX (US)

(72) Inventors: Sagi Schein, Haifa (IL); Gideon Amir, Ness Ziona (IL); Noam Shaham, Mazkeret Batia (IL); Yuri Sapozhnikov, Netaniya (IL); Hila Nachlieli, Haifa (IL)

(73) Assignee: Hewlett-Packard Development Company, L.P., Houston, TX (US)

(21) Appl. No.: 13/872,245

(22) Filed: Apr. 29, 2013

(51) Int. Cl. G06F 3/12

(52) U.S. Cl. CPC G06F 3/1218; G06F 3/1229
USPC 358/1.15

(57) ABSTRACT

According to one example, there is provided a method of determining a workflow in a production environment that comprises a plurality of production resources. The method comprises receiving a job request and determining, based on the contents of the job request and on a stored workflow history of job requests previously processed in the production environment, a predicted workflow to be used when processing the received job request.

### BACKGROUND

In a production environment the generation of a finished product may require an object or objects to be processed by one or multiple processing resources. A processing resource may, for example, be a physical machine or a human operator. Each processing resource may perform one or more processing operations on an object or objects. Once all designated processing operations have been performed, a finished product is produced.

Different kinds of finished products may be produced in a single production environment, depending on the initial objects to be processed, the processing resources used to perform the processing, the processing steps performed by each processing resource, and the order in which those processing resources are used.

An example of such a production environment is a printing production environment. In a printing production environment processing resources may include printing systems, cutting systems, laminating systems, and packaging systems. Human operators may also perform processing steps such as quality control, approval steps, product transport, and so on. Within such an environment different kinds of printed product may be produced, such as individual photo prints, photo books, ring-bound photo calendars, posters, and so on.

In printing production environments a written ‘job ticket’ (or ‘job request’) may be used to define data relating to the production of a finished product. The data may include, for example, one or more of: a product type identifier; a product definition; instruction steps for generation of the finished product; and data identifying one or multiple processing resources to be used.

Once defined, the job ticket is used by a human operator who determines an order of processing resources to be used, and processing steps to be performed at each processing resource in order to produce the finished printed product.

### BRIEF DESCRIPTION

Examples, or embodiments of the invention, will now be described, by way of non-limiting example only, with reference to the accompanying drawings, in which:

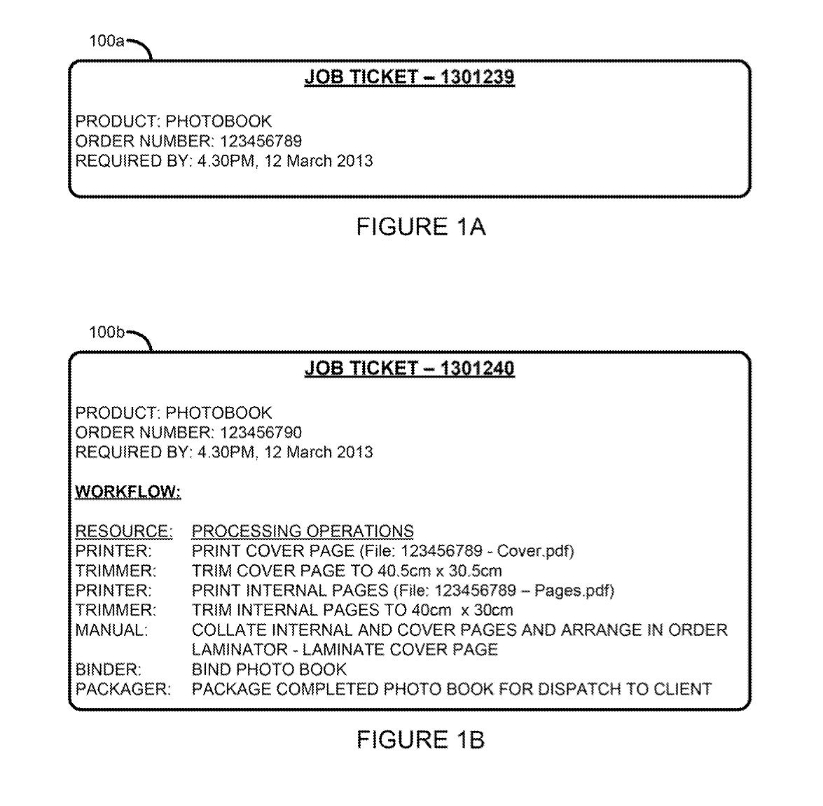

FIGS. 1A and 1B illustrate of a number of example job tickets;

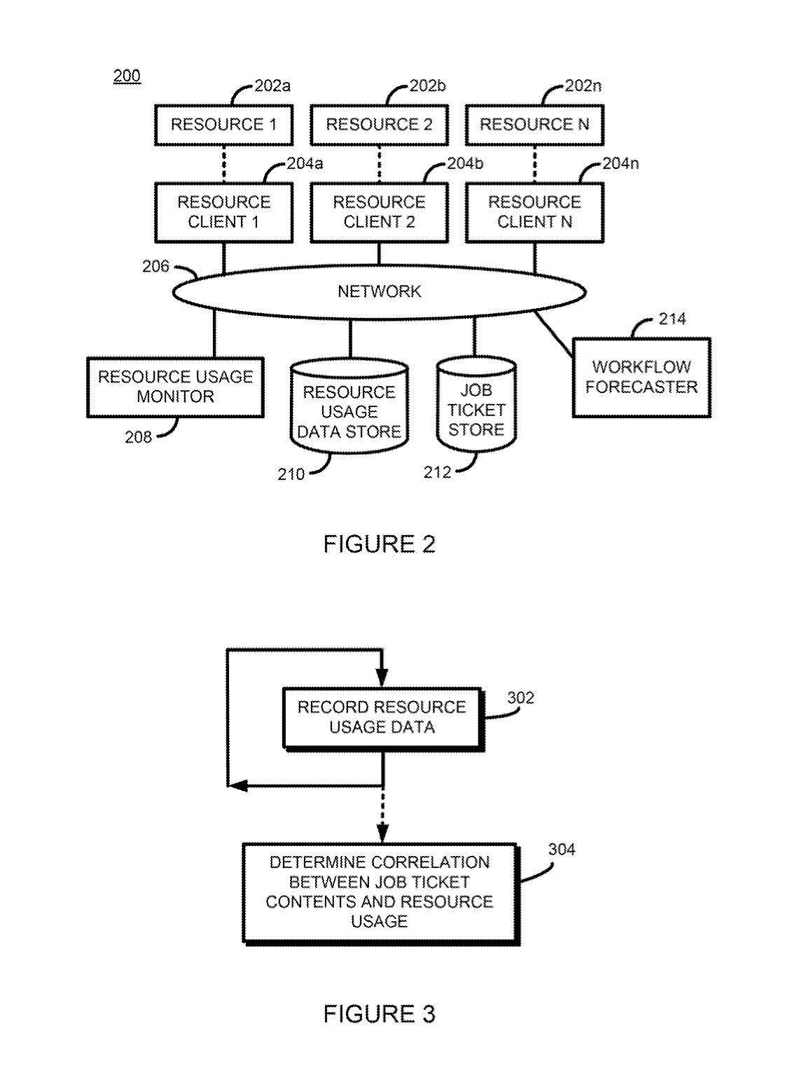

FIG. 2 is a simplified block diagram illustrating a production environment according to one example;

FIG. 3 is a flow diagram outlining a method according to one example;

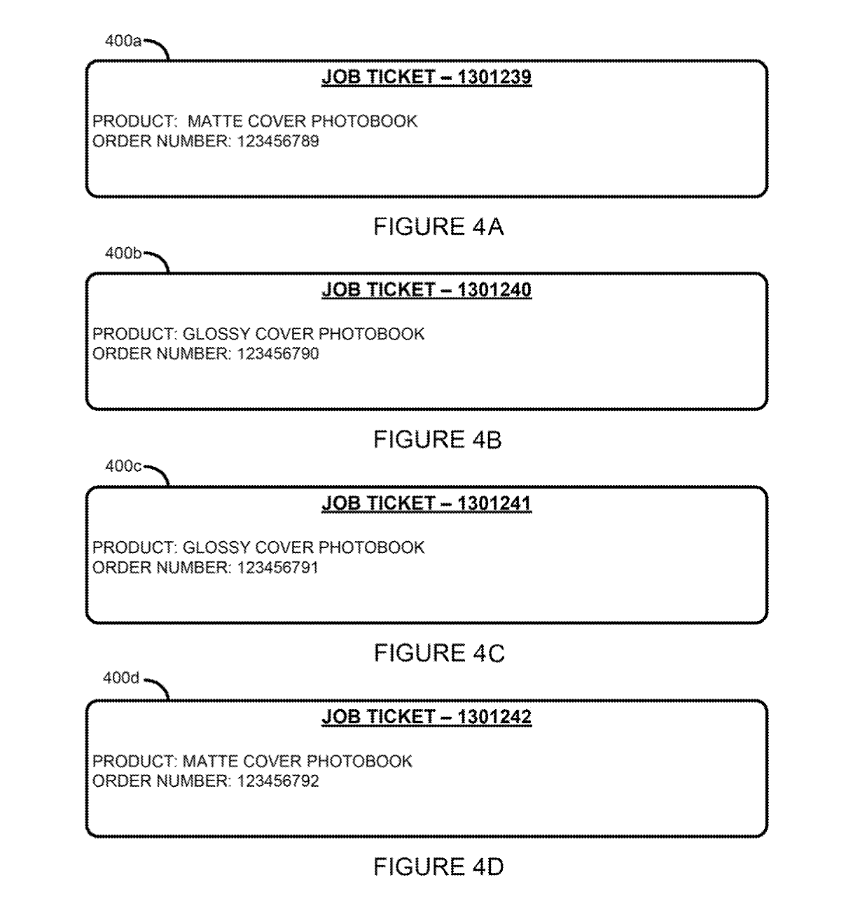

FIGS. 4A to 4D illustrate of a number of example job tickets;

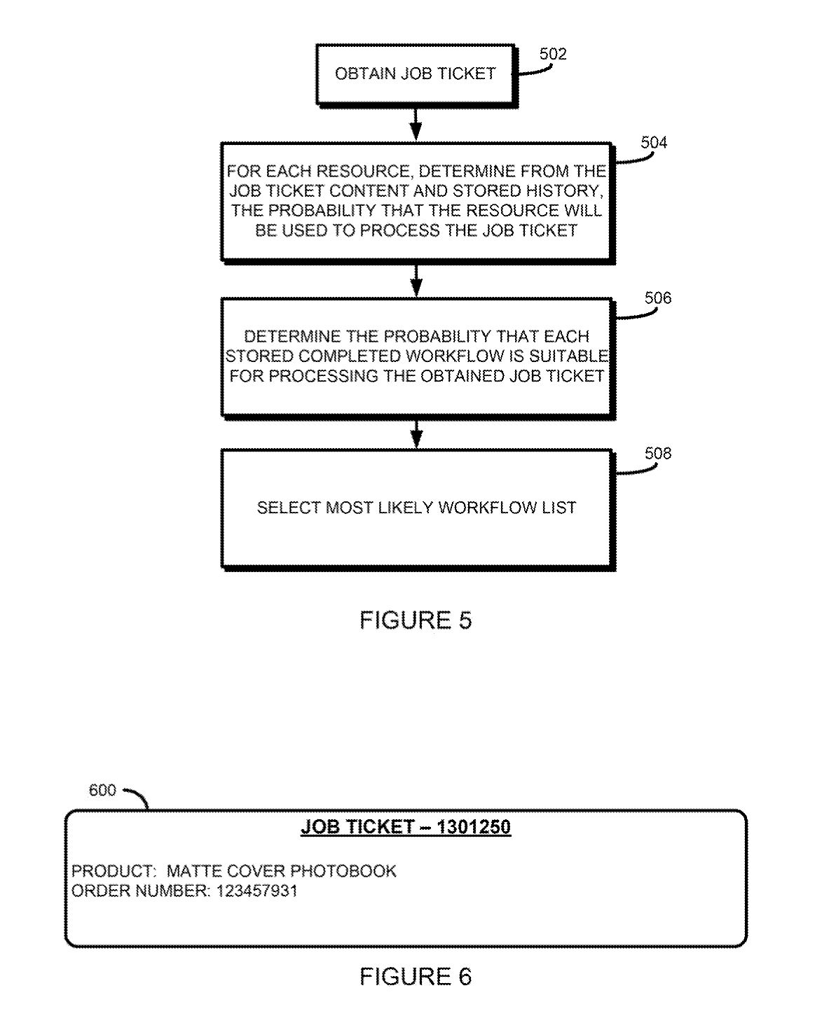

FIG. 5 is a flow diagram outlining a method according to one example;

FIG. 6 illustrates of a number of example job tickets;

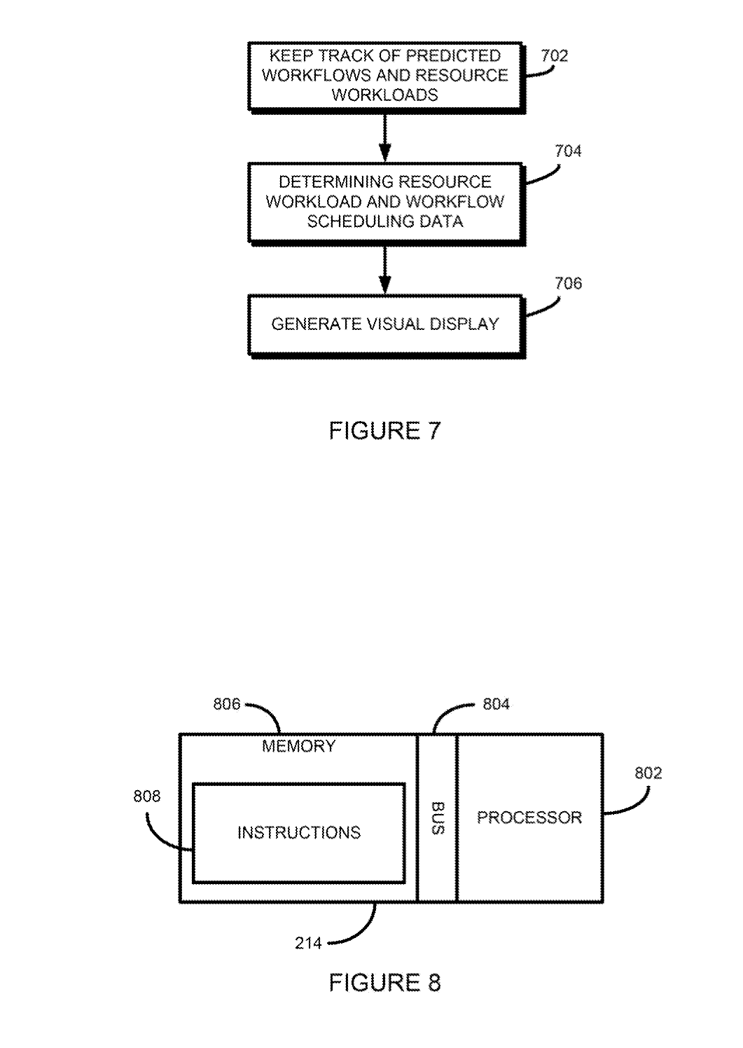

FIG. 7 is a flow diagram outlining a method according to one example; and

FIG. 8 is a block diagram of a workflow forecaster according to one example.

### DETAILED DESCRIPTION

The following description is made with reference to printing production environments. However, the techniques and methods described herein may be equally applicable, with appropriate modifications, to other appropriate production or business environments.

As already mentioned, in printing production environments a job ticket defines data relating to the production of a finished product. The term ‘finished product’ used herein is intended to mean that no further processing within the production environment is needed. In some instances some additional processing steps may need to be performed before a finished product is in a suitable state for an end customer.

In one example a job ticket may be a simple description of a product to be produced, such as ‘Photo book’. Trained operators reading the job ticket may have knowledge of the processing resources to be used to produce a ‘Photo book’, and may have knowledge all of processing steps to be performed at each processing resource.

In another example a job ticket may include one or more of: details of a product specification, details of processing resources to be used; and details of processing steps to be performed at one or more of the processing resources. For example, such a job ticket may specify some or all of the processing steps needed to produce a bound photo book. For example, such a job ticket may specify processing steps such as: printing the individual pages of the photo book; cutting the printed pages to a given size; printing a photo book cover; laminating the photo book cover; cutting the cover to a given size; assembling the individual printed pages and printed cover in the correct order; binding the printed pages and cover to form a completed photo book, and packaging the completed photo book for delivery to a customer.

In some examples a job ticket may additionally specify a processing resource which may in some examples be a generic type of processing resource and in other examples may be a specific processing resource.

In any case, an operator producing a finished product in relation to a job ticket may choose to deviate from specific instructions in the job ticket based on, for example, their experience, the availability of resources within the production environment, and so on.

In general commercial printing environments job tickets are typically written in a free text form, and are not written in accordance with any predetermined standard.

Two example job tickets 100a and 100b are illustrated in FIGS. 1A and 1B. In one example a job ticket may be provided in a suitable electronic format, such as a text file.

Within a printing production environment multiple resources of similar types may be present. For example, such an environment may comprise one or multiple color printers, one or multiple monochrome printers, one or multiple trimmers, one or multiple laminators, and so on. Each of the different resources may have different characteristics, such as different throughput characteristics, different processing size (e.g. paper size) characteristics, different cost characteristics, etc.

In low-volume or small printing production environments the manual interpretation of job tickets is possible by human operators. For example, experienced operators may be able to have a general appreciation of each of resources in a production environment, to understand their characteristics and constraints, and use their knowledge of the instantaneous or planned loads on each resource to determine, for a given job ticket, an ordered list of resources to be used to produce a finished printed product and a list of processing tasks to be performed at each resource.

However, as printing volumes increase, or in larger printing production environments, using the production environment in a more optimized manner becomes beyond the capabilities of a typical human operator. For example, larger printing production environments may comprise multiple processing resources, and be used to produce tens or hundreds of different types of finished printed products. Some job tickets may relate to short-run productions, others to long-run productions, and job tickets may have different priorities or urgencies.

Accordingly, significant benefits are obtainable by operating such production environments in a more automated and more structured manner, as will be described below with reference to examples.

Examples described herein aim to automatically determine a workflow for producing a finished printed product based on a given job ticket. Use may then be made of a determined workflow in improving the scheduling of jobs in the production environment.

According to one example described below there is provided a system and method of determining a workflow to be followed in processing a new job ticket. Further reference is made to FIGS. 2 to 6. In one example the method is performed by a workflow forecaster module, which is described in greater detail below.

Referring now to FIG. 2, there is shown a block diagram of a printing production environment 200, according to one example. The printing production environment 200 comprises a plurality of processing resources 202a to 202n. Associated with each processing resource 202 is a corresponding resource client 204a to 204n. Each resource client 204 may be any suitable computing or processing device. The resource clients 204 are connected to a network 206 such as a local area network.

In some examples a resource client 204 may be integrated into a resource, for example where the resources are substantially computer controlled resources such as printing systems. In other examples a resource client may not be integrated into a resource, for example where the resources are primarily mechanical devices such as cutters, laminators, or are human operators.

The resource clients 204 enable an operator to access an electronic job ticket stored in a job ticket store 212. In this way, whenever an operator performs a processing operation on a resource 202, data identifying the job ticket and the resource used is collected (block 302, FIG. 3) by a resource usage monitor 208 and is stored in a resource usage data store 210.

Identification of a job ticket may be achieved, for example, by scanning a bar code associated with a printed job ticket at each resource client, accessing a job ticket stored in the job ticket store 212, or in any appropriate manner.

As finished products are produced using different resources 202 of the production environment 200 a history of completed processing tasks performed by different ones of the processing resources in relation to a particular job ticket is built up and is maintained in the resource usage data store 210.

In the examples described herein the production environment 200 has four different resources. In other examples, however, a production environment may have more or less resources.

For example, once a completed photo book has been produced as a result of a job ticket, a completed workflow may record the following data:

JOB TICKET 1301239

| EXECUTED | |
|---|---|
| WORKFLOW | |
| ORDER | RESOURCE ID |
| 1 | 1 |
| 2 | 2 |
| 3 | 4 |

Each completed workflow may be stored in the resource usage data source 210 in the form of a workflow vector having in the generic form:

Workflow Vector=\vec{WF_{JOBTICKET ID}}=[Resource ID1, Resource ID2, Resource IDn]

Using this notation, the workflow vector for the above described completed photo book can be defined as:

\vec{WF_{ID:1301239}}=[1,2,4]

As job tickets are processed, completed workflow vectors are stored (block 302, FIG. 3) in the resource usage data store 210.

Periodically, a workflow forecaster 214 processes (block 304, FIG. 3) completed workflows stored in the resource usage data store 210 and job tickets stored in the job ticket store 212 to determine a correlation between the content of each job ticket and the resources identified in each completed workflow.

For the purposes of explanation a simple example with relation to a number of simple job tickets 400a to 400d as illustrated in FIGS. 4A to 4D will be described. It will be appreciated, however, that the techniques and concepts described below may equally be applied to a more complex job ticket, such as the job ticket 100b shown in FIG. 1B.

In this example, a resource having the identifier ‘1’ is a printing system, the resource having the identifier ‘2’ is a trimming system, the resource having the identifier ‘3’ is a laminating system configured to laminate with a glossy finish, and the resource having the identifier ‘4’ is a laminating system configured to laminate with a matte finish.

In this simplified example, a job ticket may designate either a photo book with a glossy cover to be produced, or a photo book with a matte cover to be produced.

After four job tickets have been processed, the following workflow vectors are stored in the resource usage data store 210.

\vec{WF_{ID:1301239}}=[1,2,4] (1)

\vec{WF_{ID:1301240}}=[1,3,2] (2)

\vec{WF_{ID:1301241}}=[1,3,2] (3)

\vec{WF_{ID:1301242}}=[1,4,2] (4)

Periodically, the workflow forecaster 214 determines (block 304, FIG. 3), for each resource, a correlation with the words in the job ticket that was processed by that resource. The term ‘words’ in this sense is intended to include any delimited sequence comprising any of: characters; numerals; and special characters.

For example, for resource 4 (the matte laminator), the workflow forecaster 214 determines a correlation with the words in each of the job tickets processed by that resource. In other words, the job ticket ID: 1302139, and job ticket ID: 1301242.

JOB TICKET: 1301239

PRODUCT:
MATTE
COVER
PHOTO BOOK
ORDER:
123456789

JOB TICKET: 1301242

PRODUCT:
MATTE
COVER
PHOTO BOOK
ORDER:
123456792

Similarly, for resource 3 (the glossy laminator), the workflow forecaster 214 determines a correlation with the words in each of the job tickets processed by that resource. In other words, the job ticket ID: 1302140, and job ticket ID: 1302141.

JOB TICKET: 1301240

PRODUCT:
GLOSS
COVER
PHOTO BOOK
ORDER:
123456790

JOB TICKET: 1301241

PRODUCT:
GLOSS
COVER
PHOTO BOOK
ORDER:
123456791

Each job ticket is represented as a binary vector of words. However, since these job tickets are generally short in nature, it is ineffective to derive meaningful statistical data therefrom.

Each of the words in each of the job tickets may be extracted to form a dictionary. In one example, the existence of a word in the job ticket is used as a correlator to the participation of a tool in a workflow.

In this example, since the number of different words in each job ticket and dictionary is small, a ‘boosting’ tool may be used. Boosting is a meta-algorithm for aggregating together multiple weak-classifiers into a single strong classifier. Using the correlation, the workflow forecaster 214 determines an estimated probability that a given word in a job ticket will cause a job ticket to be processed by a given resource.

For example, it can be seen that a job ticket containing the word ‘glossy’ has a high probability of being processed using resource 3 (i.e. the glossy laminator). Similarly, it can be seen that a job ticket containing the word ‘matte’ has a high probability of being processed using resource 4 (i.e. the matte laminator).

This process is repeated for each word found in each job ticket to generate a predicted workflow for each job ticket.

Once predicted workflow data has been determined for each resource the workflow forecaster 214 is ready to obtain a new job ticket. Using the above-described predicted workflow data, the workflow forecaster 214 is able to determine a likely workflow that may be used to process the obtained new job ticket, as will be described further with reference to FIG. 5.

At block 502 (FIG. 5), a new job ticket is obtained. For the purposes of explanation a job ticket 602 (FIG. 6) is obtained.

At block 504, the workflow forecaster 214 processes the job tickets stored in the job ticket store 212 and the stored completed workflows, and determines, for each resource in the environment 200, the probability that each resource will be used to process the obtained job ticket.

At block 506, the workflow forecaster 214 determines the probability, for each completed workflow, whether that workflow is suitable for processing the obtained job ticket.

At block 508, the workflow forecaster 241 selects the workflow that is determined to be the most suitable workflow to be used to process the obtained job ticket.

The selected most suitable workflow may be used in a production environment scheduling system to assist in managing resource workloads of resources in the production environment.

The above described method will now be described in further detail according to one example.

At block 502 (FIG. 5) a new job ticket is obtained, a simple example of which is shown in FIG. 6. The textual content 600 of the new job ticket is analyzed, along with details of completed workflows stored in the resource usage data store 210, to determine, for each resource, the probability that each resource will be used to process the new job ticket.

The workflow forecaster 214 builds a participation probability (PP) vector for the obtained job ticket. The PP vector lists all of the resources in the production environment 200, and assigns a corresponding value indicating the likelihood that each resource will be used in processing the obtained job ticket. An assigned value of 1 indicates that the resource will be used in processing the obtained job ticket, and a value of −1 indicates that the resource will be not used in processing the obtained job ticket. Intermediate values indicate the level of determined probability that the resource will be used in processing the obtained job ticket.

Various statistical computation techniques may be used to process a new job ticket and to determine the probability that each resource will be used to process that job ticket.

Thus, in the current example production environment, a determined PP vector for the obtained job ticket may be written in the form:

\vec{PP_{ID}}=[Resource1, Resource2, Resource3, . . . , ResouceN]

An example PP vector generated for the new job ticket is:

\vec{PP₁₃₀₁₂₅₀}=[0.34, 0.45, −0.52, 0.64]

Next, the workflow forecaster 214 converts each of the completed workflows into vectors having the same form as the PP vector.

For example, the completed workflow vector:

\vec{WF_{ID:1301239}}=[1,2,4]

Is converted to the form:

\vec{PP₁₃₀₁₂₃}=[1,1,−1,I]

where a ‘1’ indicates that a resource was used, and wherein a ‘−1’ indicates that a resource was not used in processing a job ticket).

A distance, in this example the square distance, between each converted workflow vector and the PP vector for the new job ticket is then calculated, for example using the formula:

SQ_{D}_{_{ID}}=Σ(\vec{[(PP]_{NEW JOB ID})}−\vec{PP_{ID}})²

In this example, suppose that the calculated square distances for each of the three stored workflows are:

SQ_{D}_{₁₃₀₁₂₃₉}=5.14

SQ_{D}_{₁₃₀₁₂₄₀}=5.94

SQ_{D}_{₁₃₀₁₂₄₁}=1.94

The workflow having the lowest calculated square distance is the workflow determined to be the most likely stored workflow to be used to process the new job ticket.

Next, the workflow forecaster 214 calculates a normalized probability in the following manner:

$$NM = Normalised Probability = \frac{1}{\frac{1}{{SQ}_{{D}_{1}}} + \frac{1}{{SQ}_{{D}_{2}}} + \frac{1}{{SQ}_{{D}_{3}}}}$$

A relative probability for each PP vector is then determined in the following manner:

$$Relative PP = \frac{NM}{{SQ}_{{D}_{n}}}$$

The relative probability for each PP vector indicates the percentage probability that each PP vector is to be used to process the new flow.

In the present example, the relative probabilities for each PP vector are determined to be:

[PP[SQ_{D}]₁₃₀₁₂₃₉]=0.22

[PP[SQ_{D}]₁₃₀₁₂₄₀]=0.19

[PP[SQ_{D}]₁₃₀₁₂₄₁]=0.59

A table may then be constructed having the following form:

| Stored Workflow Vector | SQ-D | Occurrence | Relative PP |
|---|---|---|---|
| \vec{WF_{ID: 1301239}} | 5.14 | 1 | 0.22 |
| \vec{WF_{ID: 1301240}} | 5.94 | 1 | 0.19 |
| \vec{WF_{ID: 1301241}} | 1.94 | 1 | 0.59 |

The occurrence column tallies the number of times that the same completed workflow has been used in the past.

Once the table is completed it may be sorted first by highest relative PP, and second by the highest occurrence count.

The workflow forecaster 214 determines the most likely workflow to be used to process the new job ticket is the workflow of the workflow vector having the highest relative PP and the highest occurrence count in the determined table.

As previously mentioned, one advantage of predicting workflows for new job tickets is that it enables the workload of different ones of the resources in the production environment to be estimated. For example, if multiple new job tickets are received, a predicted workflow for each job ticket is determined.

Referring now to FIG. 7, there is an outline of a method performed by the workflow forecaster 214 according to one example.

As each new ticket is processed, the workflow forecaster 214 keeps a track (block 702), for example by storing in a suitable memory, data relating to each predicted workflow for each new job ticket processed, as well as data relating to each of the estimated workloads of each of resources in the production environment.

At block 704, the workflow forecaster 214 processes the stored data to generate estimated resource workload and estimated workflow scheduling data. In generating the workflow estimate, the workflow forecaster 214 may use data contained in the new job ticket, such as required job completion time, job urgency, priority level, etc. This enables the workflow forecaster 214 to determine, for example, whether a new job ticket will be able to be processed by the required time, or whether a more optimized processing order of job tickets is possible.

At block 706, the workflow forecaster 214 generates a visual display, for example for output on a suitable visual display unit, showing scheduling data for each of the new job tickets, recommended job ticket processing orders, etc.

Using the visual output the scheduling of the processing of new job tickets may be reorganized such that the processing environment 100 is utilized in a more effective manner.

It should be noted, however, these indications are based purely on the aforementioned predicted workflows. A human operator processing a new job ticket may not be obliged to follow the predicted workflow, but may use scheduling information derived by the workflow forecaster 214 to improve the efficiency of the production environment.

In one example, as shown in FIG. 8, the workflow forecaster 214 comprises a processor 802, such as a microprocessor or microcontroller, that is coupled to, and is in communication with, via a communications bus 804, a memory 806. The memory 806 stores processor understandable instructions 808 that, when executed by the processor 802, cause the processor 802 to perform the method or methods described herein.

It will be appreciated that examples and embodiments of the present invention can be realized in the form of hardware, software or a combination of hardware and software. As described above, any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. Examples described herein may be conveyed electronically via any medium such as a communication signal carried over a wired or wireless connection and examples suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A method of determining a workflow in a production environment comprising a plurality of production resources, comprising:
receiving a job request including words relating to a job to be processed in the production environment; and
determining, based on the contents of the job request and on a stored workflow history of job requests previously processed in the production environment, a predicted workflow to be used when processing the received job request.

2. The method of claim 1, further comprising:
maintaining a stored workflow history by storing, as a job request is processed in the production environment, data relating to the resources used to process the job request and data relating to the contents of the job request.

3. The method of claim 1, wherein each workflow history is stored in the form of a workflow vector.

4. The method of claim 3, further comprising periodically processing the stored workflow vectors to determine a correlation between the content of each stored job request and the resources identified in each corresponding stored workflow vector.

5. The method of claim 4, further comprising, determining, for each historic workflow, a probability value that each historic workflow is suitable for processing the received job request.

6. The method of claim 5, further comprising, selecting the historic workflow having the highest determined probability as being suitable for processing the received job request.

7. The method of claim 6, further comprising, estimating a workload level for each resource based on the selected historic workflow.

8. The method of claim 7, further comprising, generating scheduling data indicating an order in which received job requests should be processed in the production environment.

9. The method of claim 8, further comprising generating a visual output of at least one of: the generated scheduling data; and the estimated workload level of each resource.

10. A system for determining a workflow in a production environment, comprising:
a plurality of production resources; and
a processor to:
receive an electronic job request, the job request including one or multiple words relating to a job to be processed in the production environment;
predict a set of resources to be used to process a received job request.

11. The system of claim 10, further comprising a data store for storing data relating to previously processed job requests and the resources used in relation thereto, and wherein the controller is to store in the data store data relating to previously processed job requests and the resources used in relation thereto in the form of workflow vectors.

12. The system of claim 11, wherein the controller is to periodically process the stored workflow vectors to determine correlation between resources used to process a stored job request and words contained in each stored job request.

13. The system of claim 12, wherein the controller is to process the words in a received job request and to determine a probability that each stored workflow is suitable for processing the received job request, and to determine that the stored workflow having the highest probability is the workflow suitable for processing the received job request.

14. The system of claim 13, wherein the processor determines an estimated workload for resources in the production environment based on the determined workflow.

15. The system of claim 14, wherein the processor determines scheduling data to indicate an order in which received job requests are to be processed in the production environment.
